(19) United States
(12) Patent Application Publication
(10) Pub. No.: US 2006/0113780 A1
(43) Pub. Date: Jun. 1, 2006

(54) Inflator with ignitor jet deflector

(75) Inventor: George W. Goetz, Fountain Hills, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/000,663

(22) Filed: Dec. 1, 2004

(51) Int. Cl. B60R 21/26

(52) U.S. Cl. 280/736

(57) ABSTRACT

An inflator (40) includes structure defining a fluid storage chamber (50) and an exit passage (94). A fluid (52) stored in the chamber (50), when heated beyond a predetermined temperature, undergoes one of combustion, thermal decomposition, or a change of state to result in inflation fluid. An ignitor (82), when actuated, heats the fluid (52) beyond the predetermined temperature and produces an ignitor jet (210) of combustion products directed in a first direction into the chamber (50). An ignitor jet deflector (200) deflects the ignitor jet (210) in a second direction transverse to the first direction.

### TECHNICAL FIELD

The present invention relates to an inflator for inflating an inflatable vehicle occupant protection device.

### BACKGROUND OF THE INVENTION

It is known to provide an inflator for inflating an inflatable vehicle occupant protection device. One particular type of inflator is a heated gas inflator in which a combustible inflation fluid is stored under pressure in a gas storage chamber. In one configuration, a heated gas inflator may include an inflation fluid outlet for discharging the inflation fluid and a closure member that blocks inflation fluid flow through the outlet. This inflator may also include an ignitor assembly that is actuatable to rupture the burst disk and ignite the combustible mixture of gasses. The burst disk, when ruptured, permits inflation fluid flow through the inflation fluid outlet.

### SUMMARY OF THE INVENTION

The present invention relates to an inflator that includes structure defining a fluid storage chamber and an exit passage. A fluid stored in the chamber, when heated beyond a predetermined temperature, undergoes one of combustion, thermal decomposition, or a change of state to result in inflation fluid. An ignitor, when actuated, heats the fluid beyond the predetermined temperature and produces an ignitor jet of combustion products directed in a first direction into the chamber. An ignitor jet deflector deflects the ignitor jet in a second direction transverse to the first direction.

The present invention also relates to an inflator that includes structure defining a fluid storage chamber and an exit passage. A fluid stored in the chamber, when heated beyond a predetermined temperature, undergoes one of combustion, thermal decomposition, or a change of state to result in inflation fluid. An ignitor, when actuated, heats the fluid beyond the predetermined temperature and produces an ignitor jet of combustion products directed in a first direction into the chamber. The inflator also includes means for controlling the ignitor jet to slow down the combustion, thermal decomposition, or change of state in fluid.

The present invention also relates to an inflator that includes a tubular body portion having an axis, an open first end, and an open second end. An ignitor end cap is fixed to the first end of the body portion. A closed end cap is fixed to the second end of the body portion. The body portion, ignitor end cap, and closed end cap help define a chamber of the inflator. A combustible gas is stored in the chamber. A burst disk blocks inflation fluid flow out of the chamber. An ignitor is actuatable to rupture the burst disk and direct an ignitor jet into the chamber to ignite the combustible gas. The ignitor is supported relative to the chamber by the ignitor end cap. An ignitor jet deflector deflects the ignitor jet into the chamber.

The present invention further relates to an inflator including structure defining a chamber. A combustible gas is stored in the chamber. An ignitor is actuatable to produce an ignitor jet for igniting the combustible gas. The ignitor jet is directed in a first direction into the chamber when the ignitor is actuated. An ignitor jet deflector deflects the ignitor jet in a second direction transverse to the first direction.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates an apparatus for helping to protect an occupant of a vehicle, according to a first embodiment of the present invention;

FIG. 2 is a sectional view of a portion of the apparatus of FIG. 1;

FIG. 3 is a perspective view of a portion of the apparatus of FIG. 2;

FIG. 4A is a sectional view of a portion of the apparatus of FIG. 1, according to a second embodiment of the present invention;

FIG. 4B is a perspective view of a portion of the apparatus of FIG. 4A;

FIG. 5A is a sectional view of a portion of the apparatus of FIG. 1, according to a third embodiment of the present invention;

FIG. 5B is a perspective view of a portion of the apparatus of FIG. 5A;

FIG. 6A is a sectional view of a portion of the apparatus of FIG. 1, according to a fourth embodiment of the present invention;

FIG. 6B is a perspective view of a portion of the apparatus of FIG. 6A;

FIG. 6C is a perspective view of a portion of the apparatus of FIG. 4A, according to a fifth embodiment of the present invention; and

FIGS. 7 and 8 are graphs illustrating certain performance characteristics of the apparatus.

### DESCRIPTION OF EMBODIMENTS

Representative of the present invention, an apparatus 10 helps to protect an occupant (not shown) of a vehicle 12. In the embodiment illustrated in FIG. 1, the apparatus 10 includes an inflatable vehicle occupant protection device in the form of an inflatable curtain 14. Alternatively, the apparatus 10 could include an inflatable vehicle occupant protection device (not shown) in the form of an inflatable air bag, an inflatable seat belt, an inflatable knee bolster, an inflatable headliner, or a knee bolster operated by an inflatable air bag.

The inflatable curtain 14 has a stored position (not shown) adjacent the intersection of a side structure 16 and a roof 18 of the vehicle 12. The inflatable curtain 14 is inflatable from the stored position to a deployed position, shown in FIG. 1, extending away from the roof 18 along the side structure 16. In the deployed position, the inflatable curtain 14 is positioned between the side structure 16 and any occupants (not shown) of the vehicle 12.

The apparatus 10 also includes an inflation fluid source in the form of an inflator 40 for providing inflation fluid for inflating the inflatable curtain. The inflator 40 is connected in fluid communication with the inflatable curtain 14 through a fill tube 42. Alternatively, the fill tube 42 could be omitted, in which case the inflator 40 could be connected directly to the inflatable curtain 14. The inflator 40 is actuatable to provide inflation fluid for inflating the inflatable curtain 14.

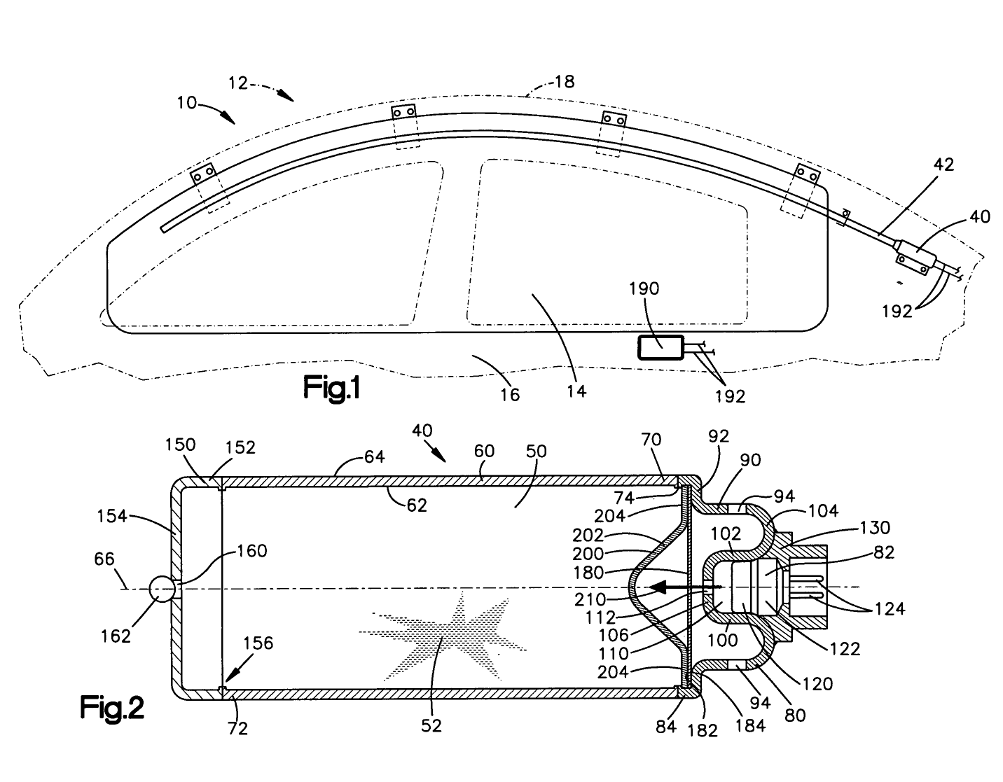

Referring to FIG. 2, the inflator 40 includes a chamber 50 in which a fluid in the form of a combustible gas 52 is stored. The combustible gas 52, when ignited, causes the inflator to produce inflation fluid for inflating the inflatable curtain 14. The combustible gas 52 may have any desired composition and may be stored at any desired pressure. For example, the combustible gas 52 may be a compressed mixture of a fuel gas and an oxidizer gas. In one example composition, the inflation fluid may include about 16% hydrogen and about 84% air.

As an alternative to the combustible gas 52, the inflation fluid may be a combustible liquid that is combusted when heated beyond the predetermined temperature or a liquid that experiences gasification upon being heated beyond a predetermined temperature. A refrigerant, such as Freon, is an example of a liquid that experiences gasification when heated beyond a predetermined temperature. As a further alternative, the inflation fluid may undergo decomposition when heated beyond the predetermined temperature. Nitrous oxide is an example of a gas that undergoes decomposition when heated beyond a predetermined temperature.

The inflator 40 includes a body portion 60, an ignitor end cap 80 that supports an ignitor 82, and a closed end cap 150. The body portion 60 has an elongated cylindrical configuration and is constructed of a high strength material, such as steel, aluminum, or other suitable metals or metal alloys. The body portion 60 includes cylindrical inner and outer surfaces 62 and 64, respectively. The inner and outer surfaces 62 and 64 are centered on a longitudinal axis 66. The body portion 60 of the inflator 40 also has opposite first and second open ends 70 and 72, respectively.

The ignitor end cap 80 is connected to the first open end 70 of the body portion 60. The ignitor end cap 80 includes an annular end portion 84 centered on the axis 66. The end portion 84 has a diameter about equal to the diameter of the body portion 60 and is configured to mate with the first open end 70 of the body portion. The end portion 84 of the ignitor end cap 80 is connected to the body portion 60 at the first open end 70 by suitable means, such as welding (e.g., a projection or friction weld). By way of example, in the embodiment of FIG. 2, the end portion 84 is connected to the first open end 70 by friction welding, which produces an annular weld curl 74 where the ignitor end cap 80 engages the body portion 60.

The ignitor end cap 80 also includes an annular outlet portion 90 that is centered on the axis 66. The outlet portion 90 has a diameter smaller than the end portion 84 and is connected to the end portion via an annular shoulder portion 92 of the ignitor end cap 80. The outlet portion 90 includes one or more outlets 94, which comprise circular openings that extend through the outlet portion.

The ignitor end cap 80 also includes an annular ignitor support portion 100 that is centered on the axis 66. The ignitor support portion 100 includes a side wall 102 that has a diameter smaller than the outlet portion 90 and is spaced radially inward of the outlet portion. The side wall 102 of the ignitor support portion 100 is connected to the outlet portion 90 by an inwardly curled portion 104 of the ignitor end cap 80. The ignitor support portion 100 also includes an end wall 106 that extends across the diameter of the side wall 102 opposite the curled portion 104. The side wall 102 and end wall 106 help define an ignition chamber 110 of the ignitor support portion 100. The end wall 106 includes an ignitor jet nozzle opening 112, centered on the axis 66, that provides fluid communication with the ignition chamber 110.

The ignitor end cap 80 supports the ignitor 82 in the ignitor support portion 100. The ignitor 82 may comprise a pyrotechnic device, such as a squib. The ignitor 82 includes a cap portion 120 that contains a volume of pyrotechnic material (not shown). The ignitor 82 also includes a support portion 122 and leads 124 through which an electrical current may be supplied to actuate the ignitor by igniting the pyrotechnic material.

An ignitor support piece 130 helps secure the ignitor 82 in the ignitor support portion 100 of the ignitor end cap 80. The ignitor support piece 130 is configured to mate with the support portion 122 of the ignitor 82. The ignitor support piece 130 is also configured to mate with the curled portion 104 of the ignitor end cap 80. The ignitor support piece 130 is connected to the ignitor end cap 80 by means, such as welding, to secure the ignitor 82 in the ignitor support portion 100. When the ignitor 82 is secured in the ignitor support portion 100, the cap portion 120 containing the pyrotechnic material is positioned in the ignition chamber 110.

The closed end cap 150 is connected to the second open end 72 of the body portion 60. The closed end cap 150 includes an annular end portion 152 centered on the axis 66 and an end wall portion 154 that extends across the end portion. The end portion 152 has a diameter about equal to the diameter of the body portion 60 and is configured to mate with the second open end 72 of the body portion. The end portion 152 of the closed end cap 150 is connected to the body portion 60 at the second open end 72 by suitable means, such as welding (e.g., a projection or friction weld).

The closed end cap 150 also includes a fill passage 160 that is centered on the axis 66 and extends through the end wall portion 154. Pressurized gasses may be introduced into the chamber 50 through the fill passage 160. A stop piece 162, such as a metal ball, may be welded to the end wall portion 154 to close the fill passage 160 and help prevent leakage through the fill passage.

The inflator 40 also includes a burst disk 180. The body portion 60, closed end cap 150, and burst disk 180 help define the chamber 50 for containing the combustible gas 52. The burst disk 180 has a generally round, disk shaped configuration and includes an annular peripheral portion 182 seated against a generally flat portion 184 of the annular shoulder 92 of the ignitor end cap 80. The burst disk 180 can be connected to the ignitor end cap 80 in a variety of manners. For example, the peripheral portion 182 of the burst disk 180 can be welded (e.g., projection welded) to the ignitor end cap 80.

The burst disk 180 may have a variety of configurations. For example, the burst disk 180 may have a generally flat configuration (shown) that deforms into a dome shape under the pressure of the combustible gas 52. As another example, the burst disk 180 may be configured to have a pre-formed domed portion (not shown) encircled by the annular peripheral portion 182. As a further example, the burst disk 180 may include score lines (not shown) that help define lines along which the disk ruptures upon actuation of the ignitor 82.

According to the present invention, the inflator 40 includes an ignitor jet deflector 200. The ignitor jet deflector 200 is connected to the ignitor end cap 80. The connection between the ignitor jet deflector 200 and the ignitor cap 80 can be achieved in a variety of manners. For example, the ignitor jet deflector 200 can be connected initially to the burst disk 180 by means, such as a weld or an adhesive. The assemblage of the burst disk 180 and ignitor jet deflector 200 can then be secured to the ignitor end cap 80 by means, such as a weld or an adhesive, to form a gas tight seal. As another example, the ignitor jet deflector 200 may be connected, e.g., welded, directly to the ignitor end cap 80. As another example, the ignitor jet deflector 200 may be connected to the ignitor end cap 80 through a press fit connection with the ignitor end cap. As a further example, the ignitor jet deflector 200 may be retained in the ignitor end cap 80 by the weld curl 74.

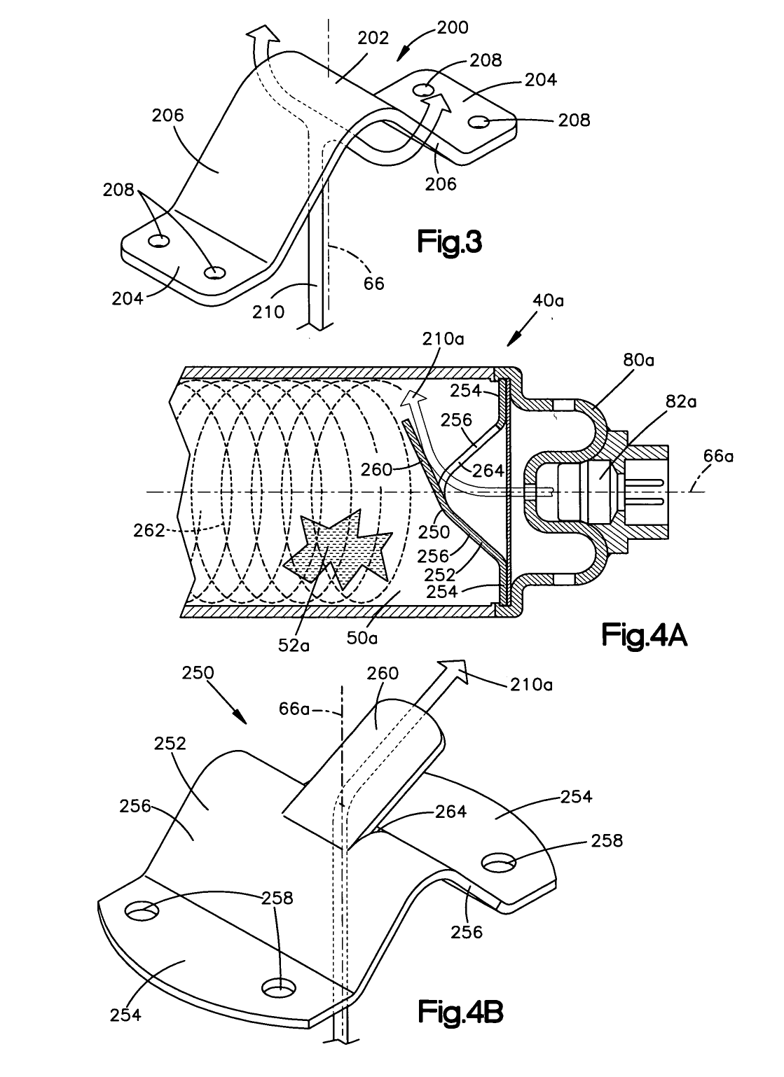

The ignitor jet deflector 200 is constructed of a material, such as steel, that is strong, machinable and workable. In the embodiment of FIGS. 2 and 3, the ignitor jet deflector 200 is formed as a strap-like length of material that is bent or otherwise deformed to form a deflector portion 202 and base portions 204 positioned on opposite sides of the deflector portion.

The base portions 204 are arranged to be co-planar with each other and may include one or more weld posts 208 (FIG. 3) for welding the deflector 200 to the ignitor end cap 80. The deflector portion 202 has a generally inverted V-shaped configuration formed by intersecting wall portions 206 that extend transverse to the base portions 204. The wall portions 206 may extend at various angles with their adjacent base portions 204 and thus at various angles relative to each other. For example, the wall portions 206 may extend at angles of about 135 degrees with their adjacent base portions 204 and at an angle of about 90 degrees relative to each other.

Referring to FIG. 1, upon sensing the occurrence of an event for which inflation of the inflatable curtain 14 is desired, such as a side impact, a vehicle rollover, or both, a sensor 190 provides an actuation signal to the inflator 40 via lead wires 192. Referring to FIG. 2, the lead wires 192 provide the actuation signal to the leads 124 of the ignitor 40. The ignitor 40 is actuated in response to receiving the actuation signal.

When the ignitor 40 is actuated, the pyrotechnic material in the cap 120 ignites, causing the cap to rupture. Combustion of the pyrotechnic material produces combustion products and a shock wave in the ignition chamber 110. The combustion products and shock wave are directed along the axis 66 by the ignitor jet nozzle opening 112, and cause the burst disk 180 to rupture.

Upon rupture of the burst disk 180, the gas 52 stored in the chamber 50 begins flowing toward the outlets 94 in the outlet portion 90. The combusting pyrotechnic material of the ignitor 40 generates an ignitor jet that may include a flame, heated particulates, or both. The ignitor jet, indicated generally by the arrow labeled 210 in FIGS. 2 and 3, is directed through the ignitor jet nozzle opening 112. The ignitor jet 210 ignites the combustible gas 52, which heats the gas in the chamber 50 and produces combustion products. A heated mixture of gasses, including the combustion products and any non-combusted gasses of the combustible gas 52 (e.g., inert gasses and/or excess oxidizer gasses), is directed through the outlets 94 toward the inflatable curtain 14 (see FIG. 1).

The ignitor jet nozzle 112 directs the ignitor jet 210 along the axis 66 into the chamber 50 and into the ignitor jet deflector 200. According to the present invention, the ignitor jet deflector 200 is adapted to deflect the ignitor jet 210. In the embodiment illustrated in FIGS. 2 and 3, the ignitor jet deflector 200 deflects the ignitor jet 210 laterally with respect to the axis 66. This is shown in FIG. 3. Since the ignitor jet 210 is directed toward the apex of the inverted V-shaped deflector portion 202, the ignitor jet deflector of FIG. 1 will deflect the ignitor jet 210 in directions perpendicular to the axis 66.

The ignitor jet deflector 200 helps limit penetration of the ignitor jet 210 into the chamber 50, which helps control combustion of the gas 52 in the chamber. Limiting penetration of the ignitor jet 210 helps contain or concentrate initial combustion of the gas 52 to the first end 70 of the chamber 50. After this initial combustion, sometimes referred to as an initial “flash,” combustion of the gas 52 travels along the length of the chamber 50 toward the second end 72. If the ignitor jet deflector 200 were omitted, the ignitor jet 210 would penetrate deeper into the chamber 50 and include a greater volume of gas 52 in the initial combustion or flash.

In reducing the initial flash of the combustible gas 52, the ignitor jet deflector 200 helps reduce the initial inflator pressure spike or rise resulting from the flash. As a result, the combusting gas 52 may have a more uniform burn rate in which the flame front travels along the chamber 50 from the first end 70 toward the second end 72. This is due to the ignition being focused at the first end 70 of the chamber 50 by the ignitor jet deflector 200.

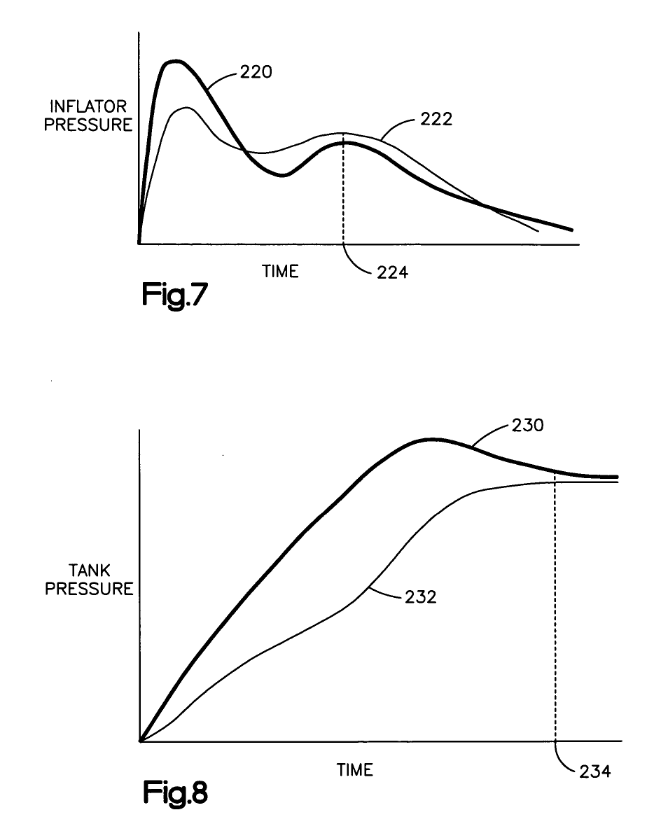

FIG. 7 shows a plot illustrating inflator pressure versus time. “Inflator pressure” refers to the gas pressure in the inflator. Referring to FIG. 7, the line identified at 220 is representative of an inflator pressure curve for an inflator that does not include the ignitor jet deflector 200 of the present invention. As shown in FIG. 7, for the inflator pressure curve 220, there is a large initial pressure spike followed by a significant pressure drop. Thereafter, the inflator pressure curve 220 settles out as the inflator discharges.

The line identified at 222 is representative of an inflator pressure curve for an inflator identical to that producing the curve 220, but including the ignitor jet deflector 200 of the present invention. As shown in FIG. 7, for the inflator pressure curve 222, the magnitude of the initial pressure spike is reduced from that of curve 220. Also, for curve 222, the pressure drop following the initial pressure spike is reduced from that of curve 220. Thereafter, the inflator pressure curve 222 settles out as the inflator discharge completes.

It should be recognized that the inflators producing the curves 220 and 222, being identical with the exception of the ignitor jet deflector 200, both discharge the same volume of gas. Such inflators will have outputs (e.g., volumetric flow rates) that follow their respective inflator pressure curves. Thus, an inflator that produces the inflator pressure curve 220 will have an initial high output corresponding to the initial pressure spike followed by a substantial reduction in output corresponding to the large pressure drop. Similarly, an inflator that produces the inflator pressure curve 222 will have an initial output reduced from that of curve 220 followed by a lesser reduction in output corresponding to the pressure drop of curve 222.

The lower initial output shown in curve 222 is made up for by the fact that, after the initial pressure drop, the inflator pressure of curve 222 is increased over that of curve 220. It will thus be appreciated that the ignitor jet deflector 200 of the present invention helps tailor the output of the inflator 40 to have a more smooth or uniform discharge characteristics.

The ignitor jet deflector 200 of the present invention, by tailoring the inflator pressure and output of the inflator 40, also helps tailor the tank pressure associated with the inflator 40. By “tank pressure,” it is meant the pressure in a closed tank into which the output of the inflator 40 is directed. An example plot illustrating tank pressure curves is shown in FIG. 8.

Referring to FIG. 8, the line identified at 230 is representative of a tank pressure curve for an inflator that does not include the ignitor jet deflector 200 of the present invention. The curve 230 is representative of a tank pressure resulting from the output of an inflator having the inflator pressure represented by the curve 220 in FIG. 7. As shown in FIG. 8, for the tank pressure curve 230, there is steep initial slope indicating a rapid increase tank pressure. This corresponds to the large initial pressure spike of the inflator pressure curve 220 of FIG. 7. Thereafter, the tank pressure curve 230 reaches a peak, settles down and then levels off as the inflator discharges completes.

The line identified at 232 in FIG. 8 is representative of a tank pressure curve for an inflator identical to that producing the curve 230, but including the ignitor jet deflector 200 of the present invention. The curve 232 is representative of a tank pressure resulting from the output of an inflator having the inflator pressure represented by the curve 222 in FIG. 7. As shown in FIG. 8, for the tank pressure curve 232, the initial slope of the curve is not as steep as the curve 230 and the curve 232 has a smoothed S-shaped form, rising gradually to and leveling off at pressure about equal to that which the curve 230 levels off. This is expected since the inflators that produce curves 230 and 232 both produce about the same volume of inflation fluid. As can be seen in FIG. 8, both inflators, i.e., the one with the ignitor jet deflector (232) and the one without the jet deflector (230), reach a desired tank pressure within the same amount of time, as indicated generally at 234. This point in time may correspond, for example to that indicated generally at 224 in FIG. 7.

A second embodiment of the present invention is illustrated in FIGS. 4A and 4B. The second embodiment of the invention is similar to the first embodiment of the invention illustrated in FIGS. 1-3. Accordingly, numerals similar to those of FIGS. 1-3 will be utilized in FIGS. 4A and 4B to identify similar components, the suffix letter “a” being associated with the numerals of FIGS. 4A and 4B to avoid confusion.

According to the second embodiment, an inflator 40a includes an ignitor jet deflector 250. The ignitor jet deflector 250 is constructed of a material, such as steel, that is strong, machinable and workable. As shown in FIGS. 4A and 4B, the ignitor jet deflector 250 is formed from a strap-like length of material that is bent or otherwise deformed to form a deflector portion 252 and base portions 254 positioned on opposite sides of the deflector portion.

The base portions 254 are arranged to be co-planar with each other and may include one or more weld posts 258 for welding the deflector 250 to the ignitor end cap 80a. The deflector portion 252 has a generally inverted V-shaped configuration formed by intersecting wall portions 256 that extend transverse to the base portions 254. The wall portions 256 may extend at various angles with their adjacent base portions 254 and thus at various angles relative to each other. For example, the wall portions 256 may extend at angles of about 135 degrees with their adjacent base portions 254 and at an angle of about 90 degrees relative to each other.

According to the second embodiment of FIGS. 4A and 4B, the deflector portion 252 includes a deflector tab 260. The deflector tab 260 comprises a portion of the deflector portion 252 that is cut out from the deflector portion. The deflector tab 260 is bent or otherwise deformed relative to the wall portions 256 to extend in a direction transverse to the axis 66a. For example, the deflector tab 260 may extend such that the angle formed between the deflector tab and the axis 66a is about sixty degrees.

The formation of the deflector tab 260 leaves an opening 264 in the deflector portion 252 through which the ignitor jet 210a is directed upon actuation of the ignitor 82a. According to the embodiment of FIGS. 4A and 4B, the ignitor jet deflector 250, particularly the deflector tab 260, deflects the ignitor jet 210a at an angle relative to the axis 66a. This deflection angle may vary depending on the angle at which the deflector tab 260 extends (e.g., sixty degrees relative to the axis 66a).

The ignitor jet deflector 250 helps limit penetration of the ignitor jet 210a into the chamber 50a, which helps control combustion of the gas 52a in the chamber. The controlled combustion also helps reduce the initial flash from the combusting gas 52a, which helps reduce the initial inflator pressure spike or rise resulting from the initial flash.

The ignitor jet deflector 250 may thus help tailor the inflator pressure and inflator output in a manner similar to that described with regard to the embodiment of FIGS. 1-3 and as illustrated in FIG. 7. In particular, the ignitor jet deflector 250 may help reduce the initial spike in inflator pressure and reduce the pressure drop in the inflator pressure following the initial pressure spike to provide a desired (e.g., smooth) inflator output.

The ignitor jet deflector 250, by tailoring the inflator pressure and output of the inflator 40a, also helps tailor the tank pressure associated with the inflator in a manner similar to that described with regard to the embodiment of FIGS. 1-3 and as illustrated in FIG. 8. In particular, the ignitor jet deflector 250 helps tailor the output of the inflator 40a to a smooth S-shaped form.

According to the embodiment of FIGS. 4A and 4B, the ignitor jet deflector 250, having the angled deflector tab 260, also helps produce a flame swirl in the chamber 50a. The ignitor jet 210a, being deflected at the angle relative to the axis 66a, causes the flames created during combustion of the gas 52a to swirl along helical paths in the chamber 50a. This flame swirl is indicated generally by the helical line at 262 in FIG. 4A. This swirling combustion helps induce swirling of the gasses in the chamber 52a, including the fuel gas and oxidizer gas.

The swirl induced in the chamber 50a by the flame swirl 262 helps mix the fuel gas and oxidizer gas of the gas 52a. This mixing helps produce a quick and uniform burn of the gas 52a in the chamber 50a. As a result, combustion of the gas 52a may be completed more quickly and the inflator 40a may discharge its volume of inflation fluid more quickly. For example, in an inflator where discharge would normally take about 65 milliseconds, the introduction of flame swirl through incorporation of the ignitor jet deflector 250 may reduce the discharge time to about 50 milliseconds.

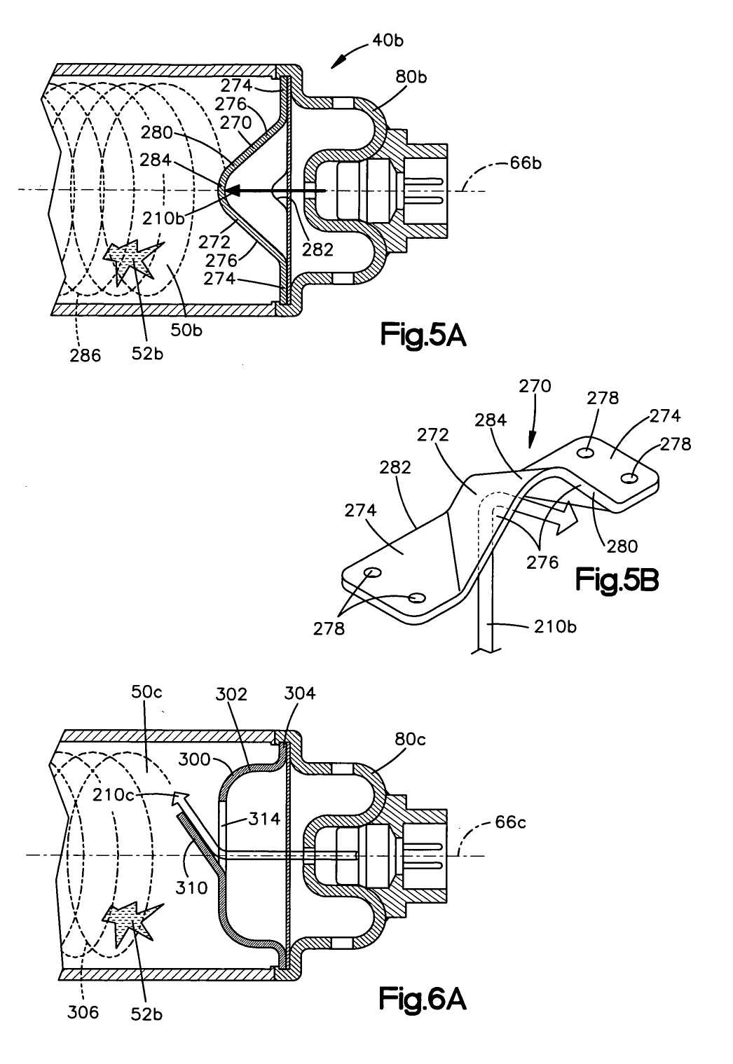

A third embodiment of the present invention is illustrated in FIGS. 5A and 5B. In FIGS. 5A and 5B, numerals similar to those of FIGS. 1-3 will be utilized to identify similar components, the suffix letter “b” being associated with the numerals of FIGS. 5A and 5B to avoid confusion.

According to the third embodiment, an ignitor jet deflector 270 is configured to deflect the ignitor jet 210b so as to introduce flame swirl in the chamber 50b. The ignitor jet deflector 270 thus functions in a manner similar or identical to that described in regard to the ignitor jet deflector 250 of FIGS. 4A and 4B. The difference between the deflector 250 (FIGS. 4A-4B) and the deflector 270 (FIGS. 5A-5B) lies in the construction of the deflector 270.

The ignitor jet deflector 270 is constructed of a material, such as steel, that is strong, machinable and workable. As shown in FIGS. 5A and 5B, the ignitor jet deflector 270 is formed from a strap-like length of material that is bent or otherwise deformed to form a deflector portion 272 and base portions 274 positioned on opposite sides of the deflector portion.

The base portions 274 are arranged to be co-planar with each other and may include one or more weld posts 278 for welding the deflector 270 to the ignitor end cap 80b. The deflector portion 272 has a generally inverted V-shaped configuration formed by intersecting wall portions 276 that extend transverse to the base portions 274. The wall portions 276 may extend at various angles with their adjacent base portions 274 and thus at various angles relative to each other. For example, the wall portions 276 may extend at angles of about 135 degrees with their adjacent base portions 204 and at an angle of about 90 degrees relative to each other.

The wall portions 276 taper down from a front edge 280 of the deflector 270 to a rear edge 282 of the deflector 270, thus giving the wall portions 276 a generally triangular profile. The wall portions 276 intersect each other at a peak 284, which follows the taper from the front edge 280 to the rear edge 282. The peak 284 is configured to extend in a direction transverse to the axis 66b. For example, the peak 284 may extend such that the angle formed between the peak and the axis 66b is about sixty degrees.

According to the embodiment of FIGS. 5A and 5B, the ignitor jet deflector 270, particularly the wall portions 276, deflect the ignitor jet 210b at an angle relative to the axis 66b. This deflection angle may coincide with the angle between the peak 284 (e.g., sixty degrees) relative to the axis 66b.

The ignitor jet deflector 270 helps limit penetration of the ignitor jet 210b into the chamber 50b, which helps control combustion of the gas 52b in the chamber. The controlled combustion also helps reduce the initial flash from the combusting gas 52b, which helps reduce the initial inflator pressure spike or rise resulting from the initial flash.

The ignitor jet deflector 270 may thus help tailor the inflator pressure and inflator output in a manner similar to that described with regard to the embodiment of FIGS. 1-3 and as illustrated in FIG. 7. In particular, the ignitor jet deflector 270 may help reduce the initial spike in inflator pressure and reduce the pressure drop in the inflator pressure following the initial pressure spike to provide a desired (e.g., smooth) inflator output.

The ignitor jet deflector 270, by tailoring the inflator pressure and output of the inflator 40b, also helps tailor the tank pressure associated with the inflator in a manner similar to that described with regard to the embodiment of FIGS. 1-3 and illustrated in FIG. 8. In particular, the ignitor jet deflector 270 helps tailor the output of the inflator 40b to a smooth S-shaped form.

According to the embodiment of FIGS. 5A and 5B, the ignitor jet deflector 270, having the inverted V-shaped deflector portion 272, also helps produce a flame swirl in the chamber 50b. The ignitor jet 210b, being deflected at the angle relative to the axis 66b, causes the flames created during combustion of the gas 52b to swirl along helical paths in the chamber 50b. This flame swirl is indicated generally by the helical line at 286 in FIG. 5A. This swirling combustion helps induce swirling of the gasses in the chamber 52b, including the fuel gasses and oxidizer gasses.

The swirl induced in the chamber 50b by the flame swirl 286 helps mix the fuel gas and oxidizer gas of the gas 52b. This mixing helps produce a quick and uniform burn of the gas 52b in the chamber 50b. As a result, combustion of the gas 52b may be completed more quickly and the inflator 40b may discharge its volume of inflation fluid more quickly. For example, in an inflator where discharge would normally take about 65 milliseconds, the introduction of flame swirl through incorporation of the ignitor jet deflector 270 may reduce the discharge time to about 50 milliseconds.

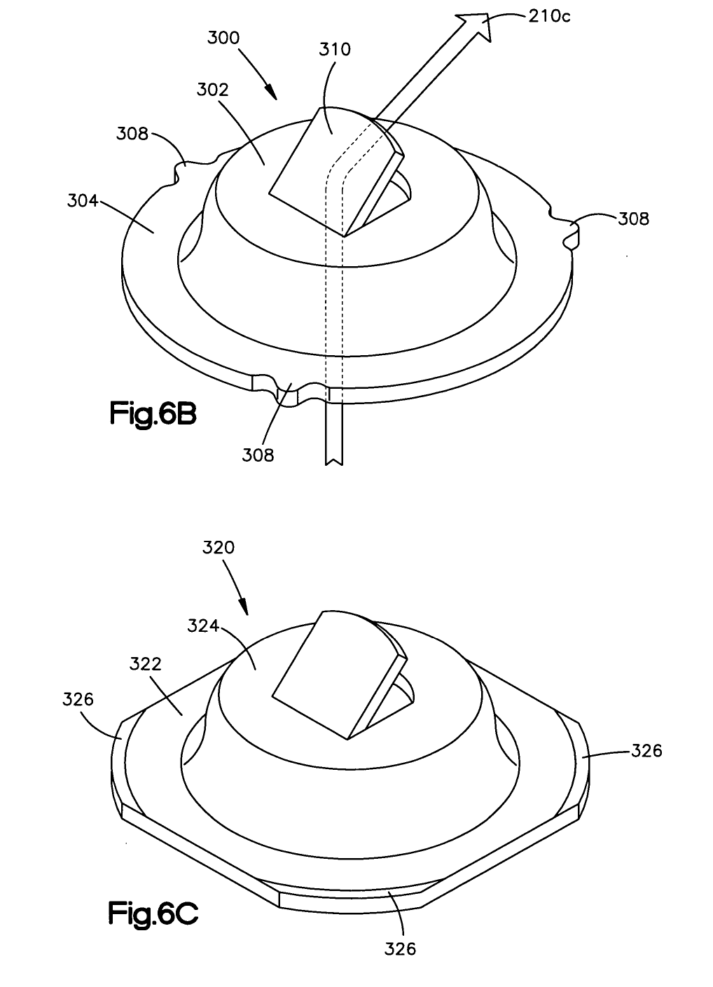

A fourth embodiment of the present invention is illustrated in FIGS. 6A and 6B. In FIGS. 6A and 6B, numerals similar to those of FIGS. 1-3 will be utilized to identify similar components, the suffix letter “c” being associated with the numerals of FIGS. 6A and 6B to avoid confusion.

According to the fourth embodiment, an ignitor jet deflector 300 is configured to deflect the ignitor jet 210c so as to introduce flame swirl in the chamber 50c. The ignitor jet deflector 300 thus functions in a manner similar or identical to that described in regard to the ignitor jet deflector 250 of FIGS. 4A and 4B. The difference between the deflector 250 (FIGS. 4A-4B) and the deflector 300 (FIGS. 6A-6B) lies in the construction of the deflector 300.

The ignitor jet deflector 300 is constructed of a material, such as steel, that is strong, machinable and workable. As shown in FIGS. 6A and 6B, the ignitor jet deflector 300 is formed from a plate material that is stamped or otherwise deformed to form a generally domed deflector portion 302 and an annular base portion 304 encircling the deflector portion. The base portion 304 may include one or more radially spaced weld tabs 308 for welding the deflector 300 to the ignitor end cap 80c.

The deflector portion 302 includes a deflector tab 310. The deflector tab 310 comprises a portion of the deflector portion 302 that is defined by a cut extending through the deflector portion. The deflector tab 310 is bent or otherwise deformed relative to the deflector portion 302 to extend in a direction transverse to the axis 66c. For example, the deflector tab 310 may extend such that the angle formed between the deflector tab and the axis 66c is about sixty degrees.

The formation of the deflector tab 310 leaves an opening 314 in the deflector portion 302 through which the ignitor jet 210c is directed upon actuation of the ignitor 82c. According to the embodiment of FIGS. 6A and 6B, the ignitor jet deflector 300, particularly the deflector tab 310, deflects the ignitor jet 210c at an angle relative to the axis 66c.

The ignitor jet deflector 300 helps limit penetration of the ignitor jet 210c into the chamber 50c, which helps control combustion of the gas 52c in the chamber. The controlled combustion also helps reduce the initial flash from the combusting gas 52c, which helps reduce the initial inflator pressure spike or rise resulting from the initial flash.

The ignitor jet deflector 300 may thus help tailor the inflator pressure and inflator output in a manner similar to that described with regard to the embodiment of FIGS. 1-3 and as illustrated in FIG. 7. In particular, the ignitor jet deflector 300 may help reduce the initial spike in inflator pressure and reduce the pressure drop in the inflator pressure following the initial pressure spike to provide a desired (e.g., smooth) inflator output.

The ignitor jet deflector 300, by tailoring the inflator pressure and output of the inflator 40c, also helps tailor the tank pressure associated with the inflator in a manner similar to that described with regard to the embodiment of FIGS. 1-3 and as illustrated in FIG. 8. In particular, the ignitor jet deflector 300 helps tailor the output of the inflator 40c to a smooth S-shaped form.

According to the embodiment of FIGS. 6A and 6B, the ignitor jet deflector 300, having the angled deflector tab 310, also helps produce a flame swirl in the chamber 50c. The ignitor jet 210c, being deflected at the angle relative to the axis 66c, causes the flames created during combustion of the gas 52c to swirl along helical paths in the chamber 50c. This flame swirl is indicated generally by the helical line at 306 in FIG. 6A. This swirling combustion helps induce swirling of the gasses in the chamber 52c, including the fuel gasses and oxidizer gasses.

The swirl induced in the chamber 50c by the flame swirl 306 helps mix the fuel gas and oxidizer gas of the gas 52c. This mixing helps produce a quick and uniform burn of the gas 52c in the chamber 50c. As a result, combustion of the gas 52c may be completed more quickly and the inflator 40c may discharge its volume of inflation fluid more quickly. For example, in an inflator where discharge would normally take about 65 milliseconds, the introduction of flame swirl through incorporation of the ignitor jet deflector 300 may reduce the discharge time to about 50 milliseconds.

A fifth embodiment of the present invention is illustrated in FIG. 6C. According to the fifth embodiment, an ignitor jet deflector 320 is identical to the ignitor jet deflector 300 (FIGS. 6A-6B) of the fourth embodiment, except that a base portion 322 that encircles the deflector portion 324 has radially spaced elongated tabs 326 that differ from the tabs 308 of FIG. 6B.

From the above description of the invention, those skilled in the art will perceive improvements, changes and modifications. Such improvements, changes and modifications within the skill of the art are intended to be covered by the appended claims.

Having described the invention, we claim the following:

1. An inflator comprising:
structure defining a fluid storage chamber and an exit passage;
a fluid stored in the chamber, said fluid, when heated beyond a predetermined temperature, undergoing one of combustion, thermal decomposition, or a change of state to result in inflation fluid;
an ignitor for, when actuated, heating said fluid beyond the predetermined temperature and producing an ignitor jet of combustion products directed in a first direction into said chamber; and
an ignitor jet deflector for deflecting said ignitor jet in a second direction transverse to said first direction.

2. The inflator recited in claim 1, further comprising a burst disk blocking inflation fluid flow out of said chamber, said ignitor when actuated rupturing said burst disk to permit inflation fluid flow out of said chamber.

3. The inflator recited in claim 2, wherein said jet deflector is connected to said burst disk.

4. The inflator recited in claim 2, wherein said ignitor jet is directed through an opening created in said burst disk when said ignitor ruptures said burst disk.

5. The inflator recited in claim 1, wherein said structure defining said chamber comprises:
a body portion including an axially extending side wall with an open first end and an open second end opposite said first end;
an ignitor end cap fixed to said first end, said ignitor end cap comprising an ignitor support portion for supporting said ignitor relative to said chamber; and
a closed end cap fixed to said second end and closing said second end.

6. The inflator recited in claim 5, wherein said ignitor jet deflector is connected to said structure defining a chamber by a weld curl formed by a friction weld connecting said ignitor end cap to said body portion.

7. The inflator recited in claim 5, wherein said ignitor support portion comprises an ignitor jet nozzle opening for directing said ignitor jet in said first direction.

8. The inflator recited in claim 7, wherein said ignitor support portion defines an ignition chamber in which said ignitor is actuated, said ignitor jet nozzle opening directing said ignitor jet out of said ignition chamber.

9. The inflator recited in claim 1, wherein said ignitor jet deflector is configured to deflect said ignitor jet into said chamber so as to create a flame swirl in said chamber.

10. The inflator recited in claim 1, wherein said ignitor jet deflector is connected to said structure defining a chamber by a weld curl formed by a friction weld connecting portions of said structure defining a chamber.

11. The inflator recited in claim 1, wherein said fluid comprises a combustible mixture of gasses stored under pressure in said chamber, said combustible mixture of gasses being combustible to produce inflation fluid.

12. The inflator recited in claim 11, wherein said combustible mixture of gasses comprises a mixture of hydrogen and air.

13. The inflator recited in claim 1, wherein said ignitor directs said ignitor jet in said first direction along an axis of said inflator, said ignitor jet deflector deflecting said ignitor jet in said second direction transverse to said axis.

14. The inflator recited in claim 13, wherein said second direction is at an angle of about 30 to 60 degrees relative to said axis.

15. The inflator recited in claim 1, wherein said ignitor jet deflector comprises a deflecting portion for deflecting said ignitor jet, said deflecting portion and having an inverted V-shaped configuration.

16. The inflator recited in claim 1, wherein said ignitor jet deflector comprises a deflecting portion including wall portions arranged in an inverted V-shaped configuration, at least one of said wall portions comprising a deflector tab extending transverse to said at least one wall portion and leaving an opening in said at least one wall portion, said ignitor jet being directed to travel through said opening and against said deflector tab.

17. The inflator recited in claim 1, wherein said ignitor jet deflector comprises a deflecting portion for deflecting said ignitor jet, said deflecting portion having an a construction in which wall portions are arranged in a generally inverted V-shaped configuration, said wall portions intersecting at a peak that tapers down from the front edge of the wall portions toward a rear edge of the wall portions.

18. The inflator recited in claim 1, wherein said ignitor jet deflector comprises a deflecting portion having a generally domed wall portion, said deflector portion comprising a deflector tab deflected away from said wall portion and leaving an opening in said wall portion, said ignitor jet being directed to travel through said opening and against said deflector tab.

19. The inflator recited in claim 1, wherein said ignitor jet deflector comprises an opening and a deflector tab adjacent said opening, said ignitor jet being directed to travel through said opening and against said deflector tab, said deflector tab being arranged to deflect said ignitor jet.

20. An inflator comprising:
structure defining a fluid storage chamber and an exit passage;
a fluid stored in the chamber, said fluid, when heated beyond a predetermined temperature, undergoing one of combustion, thermal decomposition, or a change of state to result in inflation fluid;
an ignitor for, when actuated, heating said fluid beyond the predetermined temperature and producing an ignitor jet of combustion products directed in a first direction into said chamber; and
means for controlling said ignitor jet to slow down the combustion, thermal decomposition, or change of state in said fluid.

21. An inflator comprising:
a tubular body portion having an axis, an open first end, and an open second end;
an ignitor end cap fixed to said first end of said body portion;
a closed end cap fixed to said second end of said body portion, said body portion, said ignitor end cap, and said closed end cap helping to define a chamber of said inflator;
a combustible gas stored in said chamber;
a burst disk blocking inflation fluid flow out of said chamber;
an ignitor actuatable to rupture said burst disk and direct an ignitor jet into said chamber to ignite said combustible gas, said ignitor being supported relative to said chamber by said ignitor end cap; and
an ignitor jet deflector for deflecting said ignitor jet into said chamber.

22. An inflator comprising:
structure defining a chamber;
a combustible gas stored in said chamber;
an ignitor actuatable to produce an ignitor jet for igniting said combustible gas, said ignitor jet being directed in a first direction in said chamber when said ignitor is actuated; and
an ignitor jet deflector for deflecting said ignitor jet in a second direction transverse to said first direction.
